(19) United States
(12) Patent Application Publication
(10) Pub. No.: US 2002/0036957 A1
(43) Pub. Date: Mar. 28, 2002

(54) Disk reproducing apparatus

(76) Inventor: Yasuharu Kitakami, Shirakawa (JP)

Correspondence Address: DICKSTEIN SHAPIRO MORIN & OSHINSKY LLP, Mark J. Thronson, 2101 L Street NW, Washington, DC, 20037-1526, US

(21) Appl. No.: 09/925,439

(22) Filed: Aug. 10, 2001

(30) Foreign Application Priority Data
Sep. 22, 2000 (JP) 2000-288436

(51) Int. Cl. G11B 17/22

(52) U.S. Cl. 369/30.93

(57) ABSTRACT

A reproducing apparatus comprising: a main body; a frame which can be freely pushed out from, or drawn in the main body; a disk tray which is rotatably attached to the frame, for mounting a plurality of disks; an optical pick-up unit for reproducing recording data recorded in each disk, the disk tray for rotatably moving a designated disk at the optical pick-up unit; and the designated disk being reproduced; wherein the optical pick-up unit operating along with a turn table for holding and rotating the disk, is located between the rotation center of the disk tray and the front panel the main body when the frame is drawn in said main body.

### BACKGROUND OF THE INVENTION

The present invention relates to an optical disk reproducing apparatus.

A disk reproducing apparatus disclosed in Japan Patent Publication No hei-43869 includes a tray which is drawn in or pushed out from a main body of the disk reproducing apparatus, a round table rotatably attached to this tray, a plurality of disk-holding round portions which are formed around a rotation axis on this table, a turn table separately located from that tray, a disk-clamper and an optical pick-up, recesses shaped at the disk-holding portions so as to insert the turn tables and the optical pick, a disk apparatus mechanism for setting a disk held in one of the disk-holding portions on turn table in the state in that all trays are drawn in the main body, and for clamping by the disk-clamper, an opening which is formed in the tray so that the notch in the disk-holding portion communicates with the recess at the disk reproducing position, and a mechanism in which the tray can be pushed out from the recess of the disk-holding portion and the aperture of tray while avoiding the turn table and the reproducing head.

As disclosed in this Patent Publication, a turn table is located at the back panel in the disk reproducing apparatus. Also, an optical pick-up for reproducing recording data signal in a desk, is located at back panel.

Recently, in a disk reproducing apparatus, a plurality of disks has been arranged in one disk tray. Accordingly, the sizes of a disk tray and a frame supporting the disk tray have been increased. For example, if 5 disks-changer is fabricated, the diameter of a disk tray is about 32 cm. Therefor, a frame supporting the disk tray has becomes bigger.

These issues such as the locating of the turn table and the optical pick-up at the back panel in the disk reproducing apparatus, and the increase of size of the disk tray frame, take much time for the pushing-out of the disk tray frame from or the drawing of the disk tray frame in the reproducing apparatus, and the rotatably moving the designated disk to the position of the optical pick-up located at the back art of the disk reproducing apparatus, and the starting of rotating the designated disk.

If the apparatus is a CD (Compact Disk) changer for only audio reproducing, the number of terminals attached to the apparatus has been small. However, a DVD (Digital Versatile Disk) reproducing apparatus must includes a coaxial digital audio output terminal, an optical digital audio output terminal, a video output terminal, an S-video output terminal, a color differential image output terminal, a surround audio output terminal (5.1 ch.), besides an analog audio output terminal. These output terminals are arranged to the rear panel. In this composition, an optical pickup unit, which is arranged at the rear panel side, is the obstacle to the arrangement of the output terminals. Further, depending on the number of the output terminals, since output terminals must be sometimes arranged behind the optical pick-up, it is sometimes necessary to increase the depth of the disk reproducing apparatus.

### SUMMARY OF THE INVENTION

The present invention has been achieved in consideration of the above described problems, and is aimed at providing a disk reproducing apparatus, which can reduce the time for rotatably moving a disk, to be reproduced, to the position of the optical pick-up unit, which in turn can speed up the operational start time of the reproducing disk.

Further, the present invention can provide a disk reproducing apparatus which can arrange the above-described output terminals arranges without increasing the depth of a disk reproducing apparatus.

To above objectives, the present invention provides a disk reproducing apparatus comprising: a main body; a frame which can be freely pushed out from, or drawn in the main body; a disk tray, which is rotatably attached to the frame, for mounting a plurality of disks; and an optical pick-up unit for reproducing recording data recorded in the disk;

wherein, if the disk tray rotates and transfers a designated disk to the turn table so as to reproduce the recording recorded in the disk, the disk reproducing apparatus is constructed so that an optical pick-up unit is located between of a rotation center of the disk tray and the front panel of the main body.

Also, the present invention provides a disk reproducing apparatus comprising: a main body; a frame which is pushed out from, or drawn in the main body; a disk tray, which is rotatably attached to the frame, for mounting a plurality of disks; a turn table for holding and rotating each disk; and an optical pick-up unit for reproducing recording data recorded in the disk;

wherein the optical pick-up unit is located between a rotation center of the disk tray and the front panel of the main body in the state in that the frame is drawn in the main body.

### BRIEF DESCRIPTION OF THE DRAWINGS

FIG. 1 is a perspective view of a disk reproducing apparatus of an embodiment according to the present invention.

FIG. 2 is a perspective view of a reproducing apparatus with a frame pushed out from main body with a frame drawn in the main body of an embodiment according to the present invention.

FIG. 3 is a diagram showing necessary rotation of a disk in a turn table arrangement condition (1).

FIG. 4 is a diagram showing necessary rotation of a disk in a turn table arrangement condition (2).

FIG. 5 is a diagram showing necessary rotation of a disk in a turn table arrangement condition (3).

FIG. 6 is a diagram showing necessary rotation of a disk in a turn table arrangement condition (4).

### DETAILED DESCRIPTION OF THE EMBODIMENTS

Hereafter, details of the embodiments according to the present invention will be explained with reference to the drawings.

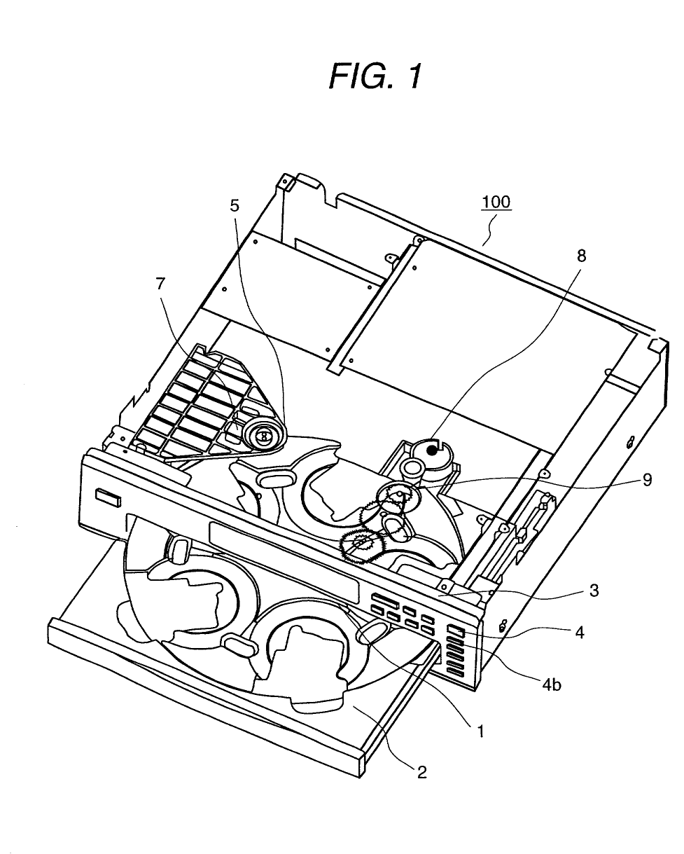

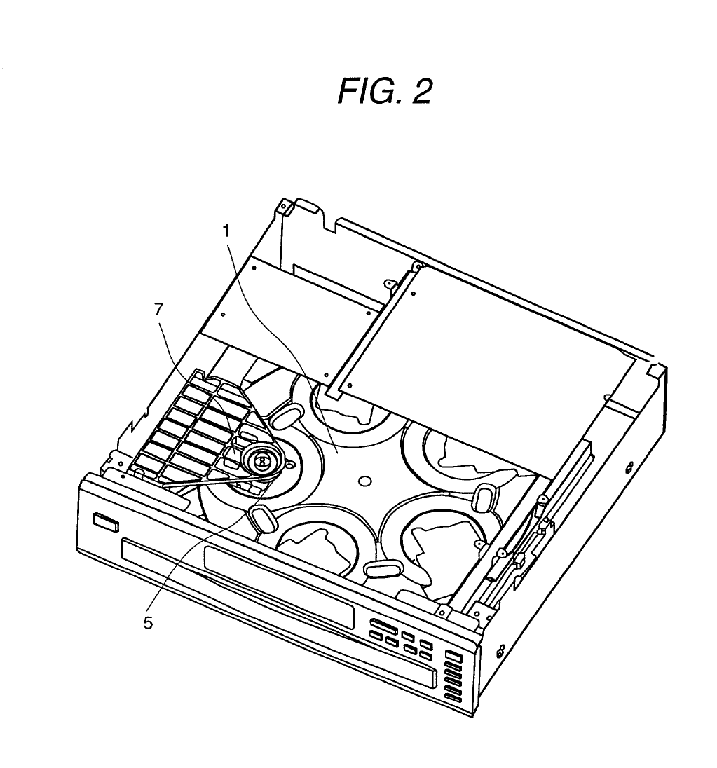

FIG. 1 and FIG. 2 are perspective views of the embodiment according to the present invention. Here, in FIG. 1, a frame is pushed out from the front part of the main body (frame open state), and in FIG. 2, a frame is drawn into the main body (frame close state).

The composition of the disk reproducing apparatus 100 is explained below.

By pushing a frame open/close button 4 provided at the front panel 3, the frame 2 and the disk trayl are pushed out forward from the main body.

Although a disk is not shown in these figures, by setting a disk in one of concave portions for setting a disk in a disk tray 1, and pushing a frame-open/close button 4, the frame 2 is drawn in the main body.

After the frame 2 is drawn in the main body, while the disk tray 1 rotates every one-fifth rotation, a disk-detection sensor 5 equipped in the main body detects a presence of a disk on each concave portion, and finds the number (No.1-No5) of the concave portion in which a disk is currently set in.

Further, by pushing a disk reproducing button 4b, the disk tray 1 is rotated, and the designated disk 6 is moved to the optical pick-up unit 7. When the rotation operations is finished, the optical pick-up unit 7 is lifted by a drive mechanism (not shown in the figures), and the disk is clamped and reproduced.

The turn table for holding and rotating a disk is comprised in the optical pick-up unit 7. Further, the optical pick-up unit 7 is arranged away from a line virtually drawn from the middle point of the front panel 11 perpendicularly to the rear panel 13. For example, as shown FIG. 1, by locating the rotation center of the turn table before even from the rotation center of the disk tray 1, which is near the front panel 11 The rotatably movement necessary for reproducing the disk 6 set in the concave portion can be reduced in the comparison with the rotatably movement under the structure that the optical pick-up unit 7 is arranged at a back panel 13 of the main body.

Furthermore, by locating the rotation center of the turn table for holding and rotating an optical disk at the position nearer the front panel in comparison with the rotation center of the disk tray 1, it is possible to decrease the time necessary for the changing of the open state of the frame 2, the drawing of the disk tray 1 mounting a disk in the main body, and the starting of reproducing the disk.

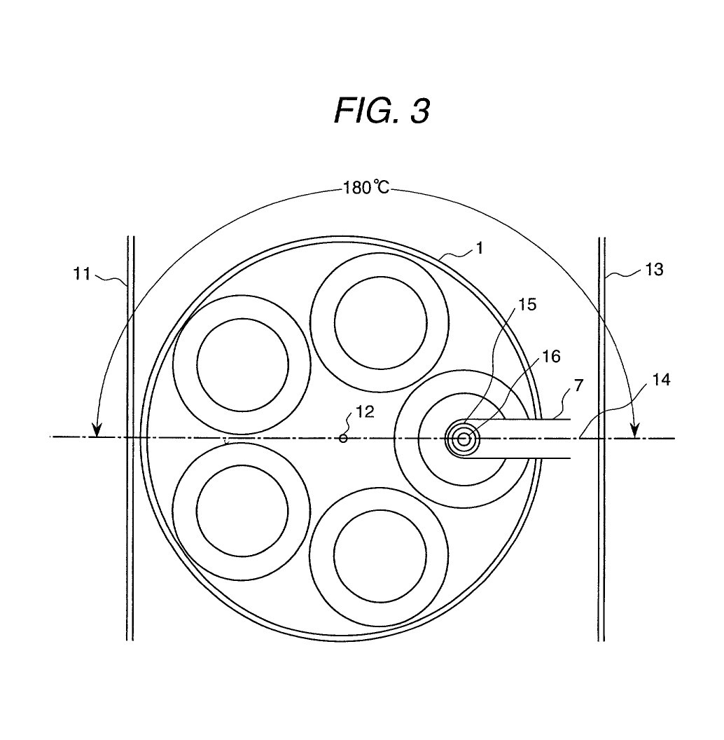

FIG. 3-FIG. 6 show examples of arrangements of three devices, that is: the optical pick-up unit 7, the turn table 15, and the disk tray 1.

In FIG. 3, the optical pick-up unit 7 and the turn table 15 are arranged on a line 14, which passes the front panel 11, through the rotation center 12 of the disk tray, the perpendicular to the back panel 13. The rotation center 16 of the disk tray is conventionally located on the line 14. The rotation angle necessary for reproducing the object disk is 180 deg. from the front panel 11.

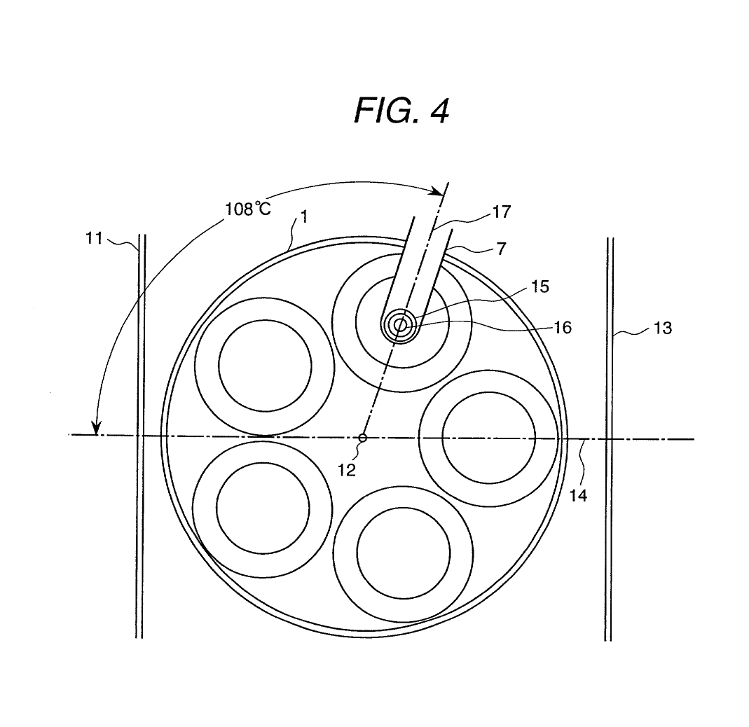

FIG. 4 shows that the line 14 intersects the line 17 between the rotation center 12 of the disk tray 1 and the rotation center 16 of the turn table at 108 deg. That is, the rotation angle necessary for reproducing the object disk is 108 deg. and 180-108=72 (deg.) can be reduced.

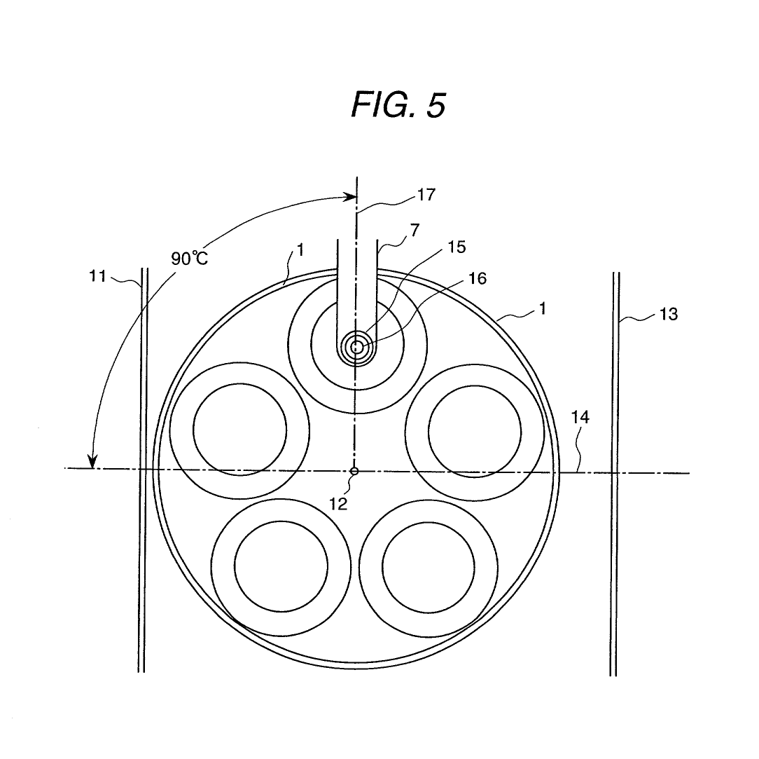

FIG. 5 shows that the line 14 intersects the line 17 between the rotation center 12 of the disk tray 1 and the rotation center 16 at 90 deg. That is, the rotation angle necessary for reproducing the object disk can be reduced by 90 deg.

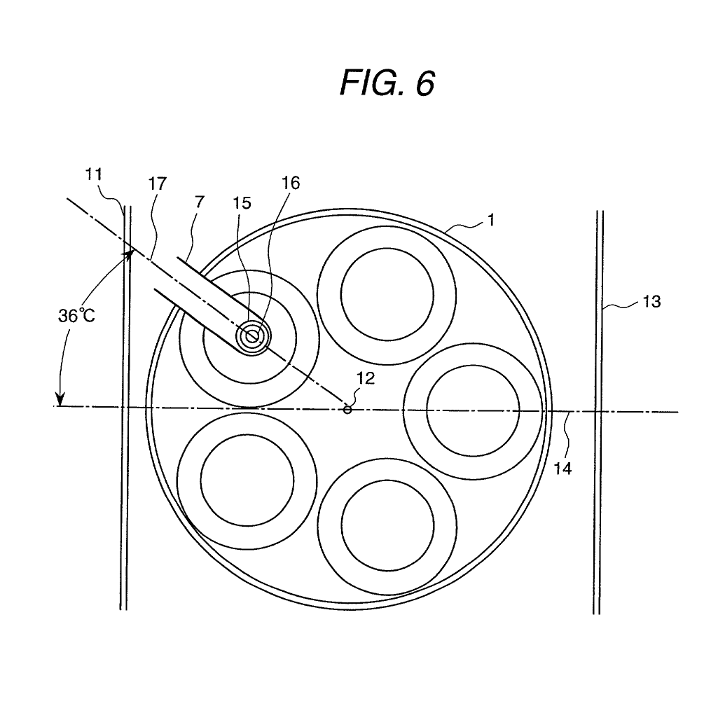

Moreover, FIG. 6 shows that the line 14 intersects the line 17 between the rotation center 12 of the disk tray 1 and the rotation center 16 of the turn table at 36 deg. That is, the rotation angle necessary for reproducing the object disk is 36 deg. and 180-36=144 (deg.) can be reduced.

According to the above structure, the disk reproducing apparatus comprises: the frame 2 drawn in and pushed out from the main body; and the disk tray mounting a plurality of disks, which is rotatably attached to the frame 2. In this disk reproducing apparatus 100, the optical pick-up unit7 for reproducing recording data recorded in a disk, when the frame 2 is stored in the main body 100, it is possible to arrange the disk tray, the turn table 15, and the optical pickup unit 7 so that the line 14 virtually drawn perpendicularly between the front panel 11 and the rotation center 12 of the disk trayl intersects the line 17 drawn between the rotation center 12 of the disk tray 1 and the rotation center 16 of the turn table 15, at the rotation angle in the range of 36-108 deg.

Further, the disk reproducing apparatus comprises: the frame 2 drawn in, and pushed out from the main body; and the disk tray 1 mounting a plurality of disks, which is rotatably attached to the frame 2 k. And, in this disk reproducing apparatus 100, since the optical pick-up unit7 for reproducing information recorded in a disk, when the frame 2 is drawn in the main body 100, and it is possible to arrange the disk tray and the optical pickup unit 7 so that the line 14 virtually drawn perpendicularly between the front panel 11 and the rotation center 12 of the disk trays back side 13 intersects the line 17 connecting between the rotation center 12 of the disk tray 1 and the rotation center 16 of the turn table 15, at the rotation angle range of 36-90 deg.

Furthermore, as described, in this embodiment, the optical pick-up unit 7 is not arranged the back panel 13 of the main body, and are arranged at a position away from the line 14 virtually drawn between the front panel 11 and the rotation center 12 of the disk tray 1. Accordingly, it is possible to implement the structure in which the rear panel 2 is near to the frame 2, and this makes it possible that many output terminals can be attached at the rear panel 13 without providing the main body case of a long depth.

For example, if the disk reproducing apparatus 100 is made for DVD, an analog audio output terminal, a coaxial digital audio output terminal, an optical digital audio output terminal, a video output terminal, S-video output terminal, a color difference image output terminal, a surround audio output terminal (5.1 ch), etc., are arranged at the rear panel.

Moreover, by providing a detection means for the pushed-out amount of the frame 2, it is possible to design the disk reproducing apparatus 100 so that the pushed-out amount of the frame 2 in the main body, and the time from drawing the frame 2 to reproducing the disk is shortened. In addition, by increasing the pushed-out amount, it also becomes possible to mount two or more disks on the disk tray.

In accordance with the present invention, the rotation center of the turn table for holding and rotating each disk (for example, this rotation center is positioned away from the above described line 14) can be located between the rotation center of the disk tray and the front panel 11, and this makes short the time from the open state of the frame to reproducing of the disk after the disk tray mounting the disk is drawn in the may body Also, if the reproducing apparatus is made for DVD, it is possible to attach the output terminals such as an analog audio output terminal, an coaxial digital audio output terminal, an optical digital audio output terminal, a video output terminal, S-video output terminal, a color difference image output, a sound audio output terminal (5.1 ch), etc., without the obstacle to the arrangement of the output terminals by the optical pick-up unit 7, and the elongation of the main body depth, or the rear panel.

Thus, it has become possible to reduce the cost of parts composing the disk reproducing apparatus.

What is claimed is:

1. A disk reproducing apparatus comprising: a main body; a frame which is pushed out from, or drawn in said main body,; a disk tray which is rotatably attached to said frame, for mounting a plurality of disks; an optical pick-up unit for reproducing recording data recorded in said disk; and a turn table for holding and rotating said disk
wherein said optical pick-up unit operated along with a turn table for holding and rotating said disk, is located between a rotation center of said disk tray and said front panel of said main body in said state in that said frame is drawn in said reproducing apparatus.

2. A disk reproducing apparatus comprising: a main body; a frame which is pushed out from, or drawn in said main body,; a disk tray, which is rotatably attached to said frame, for mounting a plurality of disks; and an optical pick-up unit for reproducing recording data recorded in said disk;
wherein said optical pick-up unit operated along with a turn table for holding and rotating said disk, is located between a rotation center of said disk tray and a front panel of said main body and said rotation center of said disk tray, at a rotation angle range of 36-108 deg., in said state in that said frame is drawn in said main body.

3. A disk reproducing apparatus comprising: a main body; a frame which is pushed out from, or drawn in said main body,; a disk tray, which is rotatably attached to said frame, for mounting a plurality of disks; and an optical pick-up unit for reproducing recording data recorded in said disk;
wherein said optical pick-up unit operating along with a turn table for holding and rotating each disk, is located so that a line between a rotation center of said disk tray and a rotation center of said turntable intersects a line virtually drawn perpendicularly between a front panel of said main body and the rotation center of said disk tray plate, at a rotation angle range of 36-90 deg., in the state in that said frame is drawn in said main body.

4. A disk reproducing apparatus according to any one of claims 1-3, various kinds of output terminals are arranged in a rear panel of said main body.
